(19) United States
(12) Patent Application Publication
(10) Pub. No.: US 2026/0103900 A1
(43) Pub. Date: Apr. 16, 2026

(54) Decorative Panel, Decorative Covering Composed of a Plurality of Such Panels, Method of Manufacturing Such a Decorative Panel and a Method of Identifying a Polymer of Such a Decorative Panel

(71) Applicant: i4F Licensing NV, Turnhout (BE)

(72) Inventor: Eddy Alberic Boucké, Turnhout (BE)

(21) Appl. No.: 19/112,399

(22) PCT Filed: Sep. 15, 2023
(86) PCT No.: PCT/EP2023/075533

§ 371 Date: Mar. 17, 2025

(30) Foreign Application Priority Data
Sep. 16, 2022 (NL) 2033065

(51) Int. Cl. E04F 15/10; B32B 3/06; B32B 27/20; E04F 15/02; G01N 23/223

(52) U.S. Cl. CPC E04F 15/107; B32B 3/06; B32B 27/20; E04F 15/02038; G01N 23/223; B32B 2264/102; B32B 2307/208; B32B 2419/00; G01N 2223/0766

(57) ABSTRACT

A decorative panel, in particular a decorative floor panel, including at least one core layer provided with an upper side and a lower side, and a decorative top structure affixed, either directly or indirectly, to said upper side of the core. Said panel, in particular said core, is at least partially composed of at least one polymer matrix embedding at least one tracer material susceptible to be identified by means of spectroscopy.

### CROSS-REFERENCE TO RELATED APPLICATIONS

This application is the United States national phase of International Patent Application No. PCT/EP2023/075533, filed Sep. 15, 2023, and claims priority to The Netherlands Patent Application No. 2033065, filed Sep. 16, 2022, the disclosures of which are hereby incorporated by reference in their entireties.

### BACKGROUND OF THE INVENTION

### Field of the Invention

The invention relates to a decorative panel, in particular a decorative floor panel, comprising at least one core layer provided with an upper side and a lower side and a decorative top structure affixed, either directly or indirectly, to said upper side of the core. The invention also relates to decorative covering composed of a plurality of mutually coupled decorative panels. The invention further relates to a method of manufacturing a decorative panel according to the invention. The present invention further relates to a method of identifying a polymer of a decorative panel according to the invention.

### Description of Related Art

Since the 1950s the use and the production of plastics increased about 10% a year globally. The demand for raw materials to produce such a polymer increases together with the demand for plastic. Recycling end-of-life products comprising polymer materials is a solution to reuse polymer materials and/or raw materials that are present in post-costumer products. Decorative panels are frequently used products comprising polymer materials and other recyclable materials. The recovery of different materials, in particular polymer materials, in post-costumer decorative panels is difficult due to a large number of polymer and additives types, grades and blends present within one panel. In addition, the materials used differ per panel. As a consequence, it is difficult to recycle decorative panels since it is hard to recognise, separate, and sort post-consumer panels based on their polymer materials.

### SUMMARY OF THE INVENTION

It is a first object of the invention to provide decorative panels with easier recyclable properties.

It is a second object of the invention to provide a method to identify and recognise one or more materials, in particular one or more polymer materials, as used in the decorative panel.

It is a third object of the invention to provide a method to identify and recognise one or more panel characteristics, in particular one or more recycling related panel characteristics, related to the decorative panel.

One or both objects can be achieved by providing a panel, in particular a decorative panel, according to the preamble, comprising:
at least one core layer provided with an upper side and a lower side,
a decorative top structure affixed, either directly or indirectly, to said upper side of the core,

wherein said panel, in particular said core layer and/or another panel layer, is at least partially composed of at least one material, preferably a polymer comprising material, and at least one tracer material embedded in and/or bonded to and/or provided onto said material, preferably a polymer comprising material, wherein said at least one tracer material is susceptible to be identified by means of spectroscopy.

Preferably, wherein said panel, in particular said core and/or another panel layer, is at least partially composed of at least one matrix (material), such as at least one polymer matrix and/or mineral matrix, at least partially embedding at least one tracer material susceptible to be identified by means of spectroscopy.

By providing such a decorative panel, the matrix, in particular the polymer and/or mineral matrix, in a post-consumer panel can be analysed, identified, and hence recognised during recycling. The advantage of being able to identify and consequently to be able to recognise a tracer material in a matrix material, in particular a polymer matrix material, in a decorative panel is that this will facilitate post-use handling, in particular recycling, of the panel, or one or more layers thereof. After having identified the tracer material(s) present in the panel, this information and/or the information derived thereof can, directly or indirectly, subsequently be used to sort and/or separate panels of different compositions, and/or to sort and/or separate panel layers of a panel according to the invention. Hence, tracer material enriched panels and/or panel layers may e.g. be separated from panels and/or panel layers which are free of any tracer material (susceptible to be identified by means of spectroscopy), and/or different panel layers of a panel with mutually different tracer materials (susceptible to be identified by means of spectroscopy) may be separated from each other. Preferably, different panels based upon different matrix materials, such as different polymer matrix materials and/or different alternative matrix materials, in particular mineral matrix materials, may be identified as being different by using different tracer materials in different panels. This allows and facilitates post-use handling, such as panel separation for example, for recycling purposes. It is conceivable that one or more mutually different tracer materials are associated to a single or the same group of materials, this may be beneficial for example to determine that certain (parts of) the panel(s) do not necessarily have to be separated for recycling purposes. It is also imaginable that after having identified the tracer material(s) present in the panel, this information and/or the information derived thereof may comprise deposit related information. Information associated to the presence of a tracer material may, directly or indirectly, subsequently be used to determine if the panel is eligible for a post-use deposit refund payment once the panel is recollected. The presence of predetermined tracer material(s) may allow for detecting whether a, preferably upfront, deposit has been paid for the respective panel, and whether this deposit can be refunded after post-use recollection of the panel (e.g. for recycling purposes). After the panel has been identified based on the information associated to the detected tracer material(s) and the deposit and/or (prepaid) deposit value has been recognized, for example by (a controller of) a return device, the user may receive a financial refund. This deposit-refund system incentivizes and facilitates recycling of panels. Recollection of such deposit panels may e.g. be at predetermined recollection locations and/or by using self-service recollection devices (return device) configured to read said deposit related information carrying element and preferably to process at least a part of the deposit-refund process.

The tracer material can be susceptible to being identified by means of atomic spectroscopy, in particular atomic emission spectroscopy (AES) and/or atomic absorption spectroscopy (AAS). AAS quantifies the absorption of electromagnetic radiation by well-separated neutral atoms, while AES measures emission of radiation from atoms in excited states. The advantage of using atomic spectroscopy is that this technique enables the determination of a tracer material embedded in a matrix, such as a polymer and/or mineral and/or wood based matrix. In addition, atomic spectroscopy is an optical sorting method which can be suitable to penetrate through the dark polymer matrix layers of a decorative floor panel to identify at least one tracer in the polymer matrix. The tracer material may e.g. be measured and identified by using Atomic Absorption Spectrophotometer (AAS), Proton and/or Induced X-ray Emission (PIXE) and X-ray Fluorescence (XRF). AAS is an analytical method used for the qualitative and quantitative determination of chemical elements, especially in trace element analysis. The process is based upon the absorption radiant energy usually in ultraviolet (UV) and visible region (V) of electromagnetic radiation. The process begins with atomization, which is a process that dissociates elements into atoms by heat of several thousand degrees but less than 3000° C. When gaseous solution is employed, emission and absorption analysis is obtained. At this temperature, only a small fraction of mono-atomic particles is excited to a higher electronic state (excited state) which emits radiation and revert back to ground state almost immediately because it has a short life span of nanoseconds. The energy of wavelength released during excited state is a characteristic of each element as they revert back to ground state. As they do, they emit electron, which is the basis of flame emission photometry. The wavelength and intensity of emission line is different for each element. Although AAS can be used to identified tracer materials in the panel, this destructive technique is typically less preferred over non-destructive techniques, such as PIXE and (XRF).

PIXE is a powerful, yet non-destructive, technique used in the determination of the elemental constituents of a material or sample. When a material is exposed to an ion beam, atomic interactions occur that give off electromagnetic radiation of wavelengths in the X-ray part of the electromagnetic spectrum specific to that element. PIXE takes advantages of the emission generated from materials by impacting sample with two types of ions which are in the form of alpha (α) particles (He⁺⁺) and protons (H⁺) at high energies. These charged particles knock out elements in the innermost electrons shell called the K-shell. To fill this vacancy, electrons from outer shells replace the inner shell electrons with a cover sponging emission in energy in the form of an X-ray. Each atom has its unique property of atoms allows the analysis of materials using PIXE. One advantage of a PIXE is that it can be performed both in vacuum as well as outside of a vacuum, in this way; whole samples such as rocks and minerals can be analysed in a non-destructive manner. Different ranges of samples such as solids (plastics, papers or metals); powdered materials (fly ash, activated carbon, catalysts, and corrosion products) liquids (oils, process waters, and solutions) and aerosol filters (thin film membrane samples) are assayed by PIXE. The Advantages of PIXE include high sensitivity, multi-element capability that analyses any element from sodium to uranium in a single spectrum, non-destructive proton beam that preserves sample after analysis. In a preferred embodiment, at least one tracer material is susceptible to be identified by means of X-ray fluorescence (XRF). The advantage of using XRF is that this technique enables the determination of a tracer material, including earth (oxide) metals, embedded in the matrix, in particular polymer matrix, in a relatively fast manner. In addition, XRF is an optical sorting method which typically can be suitable to penetrate through the dark polymer matrix layers of a decorative floor panel to identify at least one tracer in the polymer matrix. Another advantage of XRF is that it has a high identification speed and it can perform volume detection. The underlying principles of XRF are similar to PIXE. When materials are exposed to short-wavelength X-rays or to gamma rays, it leads to ionisation of their component atoms which involves ejection of one or more electrons from the atom when the atom is exposed to radiation with energy greater than its ionisation potential. X-rays and gamma rays can be energetic enough to expel tightly held electrons from the inner orbitals of the atom. The ejection of an electron in this way destabilizes the electronic structure of the atom and electrons in higher orbitals “fall” into the lower orbital to fill the hole left behind. When this happens, energy is released in the form of a photon and this energy is equal to the energy difference of the two orbitals involved. As a result, the material emits radiation, which has energy characteristic of the atoms present. The term fluorescence refers to the phenomena in which the absorption of radiation of a specific energy results in the re-emission of radiation of a different energy (generally lower). As indicated above, advantages of XRF include a non-destructive analytical technique; with relatively simple spectra line(a) void of many interferences, which can be carried out at high speed. Moreover, XRF allows multi-element analyses to be completed in few minutes and high accuracy with precision, which makes XRF typically the most preferred technique for this specific purpose of tracer material identification in (decorative) panels. Moreover, the XRF equipment is considerably less costly than PIXE equipment, which is an additional argument to prefer XRF over PIXE. Other possible spectroscopy methods in this respect are optical emission spectroscopy (OES), inductively coupled plasma atomic emission spectroscopy (ICP-AES), ICP and neutron activation analysis (gamma spectroscopy). UV spectroscopy or UV-visible spectrophotometry (UV-Vis or UV/Vis) could be used in case the decorative panel, in particular the core layer, is at least partially transparent and/or translucent.

The tracer material preferably comprises and/or consists of an element with an atomic number equal to or higher than 30. The advantage of using such a tracer material is that these elements can emit sufficient energies after being excited, whereby these energies are less prone to be absorbed by for example dust, air, or other inconvenient intervening materials in the decorative floor panel with respect to elements with an atomic number lower than 30.

The at least one tracer material can be or can comprise at least one solid metal. The at least one solid metal can be chosen from the group consisting of: Germanium (Ge), Zirconium (Zr), Niobium (Nb), Hafnium (Hf), Tantalum (Ta), Molybdenum (Mo), Iodine (I), Lutetium (Lu), and Tungsten (W). The advantage of using these solid metals is that these elements display very low toxicity and radioactivity. In addition, these solid metals are not found as additives or as natural tracer material within matrix materials, such as mineral and/or polymer based matrix materials. Therefore, the said solid metals typically can be used to identify the matrix material.

The at least one tracer material can be or can comprise a rare earth element. The at least one rare earth element can be chosen from the group consisting of: Yttrium (Y), Lanthanum (La), Neodymium (Nd), Samarium (Sm), Gadolinium (Gd), Cerium (Ce), Praseodymium (Pr), Europium (Eu), Terbium (Tb), Dysprosium (Dy), Erbium (Er), Holmium (Ho), Thulium (Tm), and Ytterbium (Yb). The advantage of using these rare earth elements is that these elements display very low toxicity and radioactivity. In addition, these rare earth elements are not found as additives or as natural tracer material within matrix materials, such as polymer(s) based matrix materials. Therefore, the said rare earth elements typically can be used to identify the matrix, in particular the polymer matrix, in a decorative panel.

The at least one tracer material can comprise at least one rare earth oxide, preferably a rare earth oxide selected from the group consisting of: Y₂O₃, La₂O₃, CeO₂, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, and Yb₂O₃. The at least one tracer material could alternatively comprise one rare earth oxide selected from the group consisting of: Y₂O₃, La₂O₃, Nd₂O₃, Gd₂O₃, Dy₂O₃, CeO₂, Pr₂O₃, Sm₂O₃, and Yb₂O₃. The at least one tracer material could optionally comprise one rare earth oxide selected from the group consisting of: Y₂O₃, La₂O₃, Pr₂O₃, Nd₂O₃, Gd₂O₃, CeO₂, Pr₂O₃, Sm₂O₃, Gd₂O₃, Er₂O₃, and Yb₂O₃. The at least one tracer material might comprise one rare earth oxide selected from the group consisting of: Eu₂O₃, Tb₂O₃, Dy₂O₃, Ho₂O₃, Er₂O₃, and Tm₂O₃. Usage of a rare earth oxide has the advantage that it is chemically the most stable form of a rare earth element.

The at least one tracer material could comprise and/or can be at least partially derived from monazite, and/or bastnaesite, and/or xenotime. The advantage of using these minerals is that they can extract the presented rare earth elements.

The tracer weight concentration of at least one tracer material in the matrix, in particular in the polymer matrix, can be in the range of 0.1 to 1.0 gram tracer material per kilogram of the matrix, in particular the polymer matrix, of the core layer and/or any other panel layer; and/or in the tracer weight concentration of at least one tracer material in the matrix, in particular in the polymer matrix, of the core layer and/or any other panel layer can be in the range of the range of 100 to 1,000 ppm. The advantage of using this tracer weight concentration is that it does not affect the properties of the polymers and/or other non-polymeric materials, used in the matrix and this concentration is cost-effective.

As indicated above, the matrix may at least partially be composed of one or more polymers. Preferably, at least one panel layer comprises at least one polymer matrix which is at least partially be composed of a polymer that is selected from the group consisting of: polypropylene (PP), polyurethane (PU), thermoplastic polyurethane (TPU), polystyrene (PS), polyethylene (PE), polyethylene terephthalate (PET), and polyvinyl chloride (PVC).

As indicated above, the matrix may at least partially be composed of one or more non-polymeric materials. The matrix may be free of any synthetic polymers and/or free of any natural polymers. Preferably, at least one panel layer comprises at least one matrix which is at least partially be composed of a non-polymeric matrix material and/or a material that is selected from the group consisting of: a mineral material, like magnesium oxide, magnesium hydroxide, gypsum, (lightweight) concrete, and/or clay; and/or a wood or a wood-based material, such as HDF or MDF, or any other thermoplastic-free material, may be used as base material.

The panel may be provided with at least one coating and/or impregnating agent, preferably wherein said coating and/or impregnating agent is provided with tracer material(s). It may be imaginable that at least one coupling profile, if provided, is impregnated, for example for improving water resistance of the coupling profiles and/or for example for smoothening coupling of coupling profiles of adjacent panels. By including one or more tracer materials in the impregnating agent, this may simultaneously be used for associating panel characteristics. Alternatively and/or additionally, the panel may comprise at least one coating, and/or a top-coat, and/or lacquer layer, and/or wear layer or the like. It may be conceivable that at least one of said layers comprises, or is provided with, one or more tracer materials, preferably characterizing said layer(s) and/or a polymer or other constituent present in said layer(s).

At least one secondary tracer material may comprise, and/or be partially composed of magnetic material, in particular magnetic particles, which may e.g. be composed of iron and/or cobalt and/or nickel. Said magnetic material is preferably selected from a group consisting of magnetite, ferro-silicon and ferrous metal particles. These magnetic particles may be present in at least one panel layer in an amount of 0.01% to 5% percent by weight of the panel layer. The magnetic particles are commonly embedded in a polymeric material (polymeric matrix) of said panel layer. The presence of magnetic particles may further facilitate post-use separation of different materials of the panel, preferably after delamination and/or shredding of layers of the decorative panel. By applying a magnetic field the magnetic particles or part can be separated from the non-magnetic particles or parts. Different panel layers may be provided with different concentrations of magnetic particles to realize different levels of enhanced magnetic susceptibility between layers. By subsequently applying magnetic fields with different magnetic field strengths a more sophistic magnetic separation can be realized.

The decorative top structure of the decorative panel could comprise a plurality of layers. The decorative top structure could at least partially be composed of a polymer material. The decorative top structure might comprise at least one layer which can comprise a polymer matrix and at least one tracer material embedded into said polymer matrix.

The at least one core layer can comprise a polymer matrix and at least one tracer material. The at least one core layer could comprise a polymer matrix with a plurality of polymers. The core could also be free of polymer materials.

The at least one first panel layer could comprise a first matrix, such as a first polymer matrix, and at least one first tracer material, and wherein at least second panel layer might comprise a second matrix, such as a second polymer matrix, and at least one second tracer material. The first (polymer) matrix and the second (polymer) matrix could at least partially be composed of the same polymer. The first (polymer) matrix and the (second) polymer matrix could at least partially be composed of different polymers. The first tracer material and second tracer material could be identical tracer materials. The first tracer material and second tracer material could be different tracer materials.

Preferably, each tracer material is assigned to a specific material and/or a specific material combination used in the panel. Said specific material may be a polymer or a non-polymeric material. Said specific material may be a main constituent of a matrix material used in the panel. However, said specific material may also a specific additive or alternative material used in the panel. It is also imaginable that a tracer material or combination of tracer material is assigned to a (predefined) specific combination of materials. This combination of materials may even form an entire material recipe (list of constituents) present in a layer or combination of layers. For example, tracer material A may be assigned to a combination of polymer type B provided with additives C and D. Numerous variants are imaginable in this context. This makes a specific tracer material (or combination of tracer materials) characterizing for a specific material and/or specific material combination used in the panel. Here, for example, preferably each polymer type is assigned to its own tracer material or tracer material combination. In this manner, the tracer material or combination of tracer materials identified forms a legend which directly leads to the polymer used in the panel or in at least one panel layer. Hence, it is preferred that the first polymer matrix and the second polymer matrix (if used) could at least partially be composed of different polymers, wherein the first tracer material is embedded in the first polymer matrix and the second tracer material, distinguishable from the first tracer material, is embedded in the second polymer matrix.

As indicated above, at least one panel layer can comprise a plurality of different tracer materials susceptible to be identified by means of spectroscopy, in particular atomic spectroscopy, such as XRF.

The at least one tracer material could be substantially homogeneously embedded in the polymer matrix. This has the advantage that the tracer material can be identified at any location of the panel. Moreover, in case the panel is cut into pieces, for example during installation of the panel and/or during post-use processing, the polymer-tracer combination remains detectable for sorting, separating, and/or recycling purposes. It is also imaginable that the at least one tracer material is non-homogeneously embedded in the polymer matrix. This makes the production process of the decorative panel, in particular of the tracer material comprising panel layer, possibly less critical. This latter may possibly lead to a discontinuous detection of tracer material in the decorative panel layer but for the aimed purpose this discontinuity is normally not critical.

Optionally, the tracer material is only embedded in the polymer matrix at at least two, preferably all, edges and/or edge zones (edge portions) of the panel to only be identified at these locations. Since at least a part of the original edge will be and will stay present in cut panels, the panel composition can still be identified by means of the tracer material. This local embedment of the tracer material will save tracer material, which is typically favourable from at least an economic point of view. At least a portion of the panel may be provided with at least one coating. Similarly, a portion may be impregnated, wherein the coating and/or impregnated portion comprises at least one tracer material. Optionally, at least one coupling profile is at least partially impregnated with and/or coated, wherein said impregnated portion and/or coated portion may comprise tracer material. Since coupling profiles typically are (visibly) exposed, this region may be easily accessible for detecting the tracer material, whilst at the same time only requiring a minimum amount of tracer material.

The decorative top structure could comprise at least one decorative layer, preferably a digitally printed decorative layer, and at least one transparent and/or translucent layer covering said decorative layer at least partially. The at least a part of the decorative top structure can be releasably affixed to the core layer.

The panel can comprise at least one backing layer, either directly or indirectly, releasably affixed to the lower side of the core. The core layer and the backing layer can at least partially be composed of the same polymer. Optionally, the core and the backing layer can be composed of one or more different polymers. The backing layer may also be composed of another material, such as cork and/or felt. The at least one backing layer may comprise at least one tracer material, in particular a polymer matrix wherein at least one tracer material is embedded into said polymer matrix.

The at least one polymer matrix can at least partially be composed of a polymer formed by a mixture of virgin polymer material and recycled polymer material. The at least one polymer matrix can be enriched with at least one additive, preferably at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, a(nother) natural filler, a(nother) (auxiliary) polymer, such as an elastomer and/or latex. Optionally, at least one additive is provided with at least one tracer material. The filler, such as limestone particles, may for example be coated with tracer material and/or infused with tracer material. It is also imaginable that rubber and/or elastomeric parts (particles) are dispersed within the composite to improve the flexibility and/or impact resistance at least to some extent. The core may (thus) be rigid, semi-flexible, or flexible, and so can be the floor covering element as such. The filler may be formed by fibres, such as glass fibres or synthetic or genuine leather fibres, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron. The primary role of this kind of filler is to provide the core, and the panel as such, sufficient hardness and/or to decrease the cost price of the core, and hence of the panel. Moreover, this kind of filler will typically also improve the impact strength of the core and of the panel as such. Preferably, the filler content in the composite material of the core is between 30 and 75% by weight of the composite material of the core, more preferably between 50 and 60% by weight of the composite material of the core. Preferably, the polymer content in the composite material of the core is between 25 and 70% by weight of the composite material of the core, more preferably between 40 and 50% by weight of the composite material of the core. The polymer can either be foamed or unfoamed. Preferably, the composite of the core comprises at least one filler selected from the group consisting of: a salt, a stearate salt, calcium stearate, and zinc stearate. Stearates have the function of a stabilizer, and lead to a more beneficial processing temperature, and counteract decomposition of components of the composite during processing and after processing, which therefore provide long-term stability. Instead of or in addition to a stearate, for example calcium zinc may also be used as stabilizer. The weight content of the stabilizer(s) in the composite will preferably be between 1 and 5%, and more preferably between 1.5 and 4%. The composite of the core preferably comprises at least one impact modifier comprising at least one alkyl methacrylate, wherein said alkyl methacrylate is preferably chosen from the group consisting of: methyl methacrylate, ethyl methacrylate, propyl methacrylate, isopropyl methacrylate, t-butyl methacrylate and isobutyl methacrylate. The impact modifier typically improves the product performance, in particular the impact resistance. Moreover, the impact modifier typically toughens the core layer and can therefore also be seen as toughening agent, which further reduces the risk of breakage. Often, the modifier also facilitates the production process, for example, as already addressed above, in order to control the formation of the foam with a relatively consistent (constant) foam structure. The weight content of the impact modifier in the composite will preferably be between 1 and 9%, and more preferably between 3 and 6%. At least one plastic material used in the core layer is preferably free of any (toxic) plasticizer in order to increase the desired rigidity of the core layer, which is, moreover, also favourable from an environmental point of view. The core and/or another layer of the panel may comprise wood-based material, for example, MDF, HDF, wood dust, bamboo, prefabricated wood, more particularly so-called engineered wood. This wood-based material may be part of a composite material of the core.

It is imaginable that the core, and/or at least one core layer (and/or another layer), comprises a composite of at least one polymer and rice. Preferably, the rice is formed by rice hulls, more preferably a mixture of separated rice hulls and/or ground rice hulls and/or rice hull powder. Preferably, the different rice hull types have different average particle sizes. The polymer(s) act(s) as polymeric binder, wherein preferably an at least partially recycled plastic polymer, such as TPU, PP, PE, PET, and/or PVC, is used. The unground rice hull can for example be present in an amount of 1-98% by weight relative to the weight rice hull mixture. Likewise, the ground rice hull and powdered rice hull can also be present in an amount of 1-98% by weight relative to the weight of the rice hull mixture. Preferably, in one embodiment the rice hull mixture comprises 20-50% by weight of each of the unground rice hull, the ground rice hull and the rice hull powder. In a particularly preferred embodiment, the rice hull mixture comprises about 33% by weight of each of the unground rice hull, the ground rice hull and the rice hull powder. The amount of the polymeric binder present in the rice hull mixture can vary and may e.g. be 1-30%, preferably 10-25%, more preferably 12-20% by weight of the rice hull mixture. The rice hull powder preferably has an average particle size of 0.175-1.20 millimetre.

It is imaginable that at least one core layer (and/or at least one other layer) comprises rice hulls, rice straw, and vegetable adhesive. Preferably, the vegetable adhesive comprises natural grass and/or wood dust. Preferably the natural grass comprises any one or more selected from the group consisting of rice grass, glutinous rice grass, and starch grass. Preferably, rice straw and/or rice hulls is/are used in an amount of 20-50%, preferably 40-50%, more preferably 35-45%, by weight based upon the weight of the (core) layer in which the rice straw and/or rice hulls is/are incorporated, in particular embedded. When more than 50% by weight of rice straw is included, there may be a problem that the moisture resistance drops significantly, while applying less than 20% by weight of rice straw the binding force may drop. Preferably, the vegetable adhesive is used in an amount of 1-20% by weight of the (core) layer.

The rice hull may be added as a main component of a thermal insulation material to provide porosity, thereby providing thermal and acoustic insulation effects. The rice straw may be added to provide binding to the insulation. Preferably, the straw is cut to an appropriate length and preferably 3 centimetre or less.

The vegetable adhesive (vegetable binder), which may be used in at least one core layer (and/or at least one other layer), preferably uses trees such as natural grass, pine bark, rubber trees, and the like prepared by mixing rice flour such as rice grass, glutinous rice grass, starch grass, and gluten with water. Preferably, the use of a mixture of natural grass and trees is preferred in terms of improving moisture resistance. When natural grass and tree-like liquid are mixed and used, the mixture is preferably used at a ratio of 2.5:7.5 to 6.5:3.5.

In a preferred embodiment of the invention, at least one core layer and/or at least one other layer comprises a mixture of clay, in particular kaolin clay, and rice, in particular rice hull. The clay serves to increase the flash point of rice, in particular the rice hulls, which is advantageous from a fire safety point of view, and moreover serves to further increase the strength of the core layer (and/or other layer) in which the clay and rice are incorporated, in particular embedded.

Preferably, the panel comprises a first panel edge comprising a first coupling profile, and a second panel edge, preferably opposing said first panel edge, comprising a second coupling profile being designed to engage interlockingly with said first coupling profile of an adjacent panel, preferably both in horizontal direction and in vertical direction.

Preferably, the first coupling profile and the second coupling profile are configured such that two of such panels can be coupled to each other by means of a turning movement and/or by means of a vertical movement.

It is often preferred that the panel comprises at least one third coupling profile and at least one fourth coupling profile located respectively at a third panel edge and a fourth panel edge. Preferably, the third coupling profile and the fourth coupling profile are configured such that two of such panels can be coupled to each other by means of a turning movement.

In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces.

In the abovementioned embodiment, it is imaginable that the first coupling profile (and/or third coupling profile) and the second coupling profile (and/or fourth coupling profile) are configured such that in coupled condition a pretension is existing, which forces coupled panels at the respective edges towards each other, wherein this preferably is performed by applying overlapping contours of the first coupling profile (and/or third coupling profile) and the second coupling profile (and/or fourth coupling profile), in particular overlapping contours of downward tongue and the upward groove and/or overlapping contours of the upward tongue and the downward groove, and wherein the first coupling profile (and/or third coupling profile) and the second coupling profile (and/or fourth coupling profile) are configured such that the two of such panels can be coupled to each other by means of a fold-down movement and/or a vertical movement, such that, in coupled condition, wherein, in coupled condition, at least a part of the downward tongue of the second coupling profile (and/or fourth coupling profile) is inserted in the upward groove of the first coupling profile (and/or third coupling profile), such that the downward tongue is clamped by the first coupling profile (and/or third coupling profile) and/or the upward tongue is clamped by the second coupling profile (and/or fourth coupling profile).

It is imaginable that the first coupling profile is configured to co-act with the second coupling profile as well as with the fourth coupling profile, and that the third coupling profile is also configured to co-act with the second coupling profile as well as with the fourth coupling profile. It is imaginable that the first coupling profile and the fourth coupling profile are identical.

In an embodiment of the panel according to the invention, the first coupling profile and/or the third coupling profile comprises: a sideward tongue extending in a direction substantially parallel to the upper side of the core, at least one second downward flank lying at a distance from the sideward tongue, and a second downward groove formed between the sideward tongue and the second downward flank, and wherein the second coupling profile and/or the fourth coupling profile comprises: a third groove configured for accommodating at least a part of the sideward tongue of the third coupling profile of an adjacent panel, said third groove being defined by an upper lip and a lower lip, wherein said lower lip is provided with an upward locking element, wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

It is conceivable that each first coupling profile and each third coupling profile is compatible—hence may co-act and interlock—with each second coupling profile and each fourth coupling profile. This may also apply in case interlocking coupling profiles do not have a completely complementary shape.

In a preferred embodiment, at least a coupling profile, and preferably all coupling profiles, is/are at least partially formed by the core.

The invention also relates to a decorative covering composed of a plurality of, preferably interconnected, decorative panels according to the invention. In a preferred embodiment, said covering comprises sawn panel parts and/or cut panel parts, wherein each panel part is provided with at least one identifiable tracer material embedded in the polymer matrix.

The invention further relates to a method of manufacturing a decorative panel, comprising the steps:
A) preparing a mixture comprising at least one material, such as a polymer, and at least one tracer material susceptible to be identified by means of spectroscopy, preferable atomic spectroscopy, more preferably XRF,
B) processing said mixture to form at least one panel layer, such as at least one core layer,
C) affixing, for example, gluing and/or fusing, at least one other panel layer onto the at least one panel layer formed during step B),

wherein at least one panel layer of said panel layers constitutes a core layer and at least one other panel layer of said panel layers forms or makes part of a decorative structure of the panel.

Preferable during step B), a matrix, such as a polymer matrix, is formed in which said at least one tracer material embedded.

Preferably, the mixture preparing during step A) is based upon and/or retrieved from a predefined material identifier list, wherein said material identifier list comprises a list of a plurality of applicable materials and/or combinations of material, wherein each material and/or each combination of materials is assigned to at least one unique tracer material and/or at least one unique combination of tracer materials, allowing the at least one material applied to be identified by means said at least one assigned tracer material susceptible to be identified by means of spectroscopy, preferable atomic spectroscopy, more preferably XRF. The material may be or comprise a polymeric material and/or a non-polymeric material. In case of the use of polymers each polymer and/or each combination of polymers is preferably assigned to at least one unique tracer material and/or at least one unique combination of tracer materials, allowing the at least one polymer applied to be identified by means said at least one assigned tracer material susceptible to be identified by means of spectroscopy, preferable atomic spectroscopy, more preferably XRF.

It is preferred that the laminate of panels created during step C) is cut into panels in a subsequent step D).

Preferably, the panel is provided with complimentary coupling profiles with at least one pair of panel edges, preferably by means of milling.

The invention further relates to a method of identifying at least one polymer of a decorative panel, comprising the steps of:
i. analysing at least one panel and/or at least one panel part for its elemental composition using an elemental spectroscopic analysis system,
ii. determining the identity of at least one tracer material present in the panel based upon the analysis results collected in step i), preferably by using said analysis system, and
iii. determining the identity of at least one polymer used in the panel, based upon the one or more tracer materials determined during step ii), by retrieving said polymer identity from a predefined matrix material list, which may be a polymer identifier list, wherein matrix material list, preferably said polymer identifier list, comprises a list of a plurality of applicable matrix materials, such as polymers and/or combinations of polymers, wherein each matrix material, such as each polymer and/or each combination of polymers, is assigned to at least one unique tracer material and/or at least one unique combination of tracer materials.

Alternatively, the method according to the invention may also be applied to identifying at least one non-polymeric material used in a decorative panel, and/or a combination of at least one polymer and/or at least one non-polymer used in a decorative panel. To this end, a cross-reference between each material and/or combination of materials and at least one (unique/predefined) tracer material and/or (unique/predefined) combination of tracer material is preferably used during step iii) to determine the identity of the material(s).

In the abovementioned method, it is preferred that during step i) the at least one panel and/or at least one panel part is subjected to electromagnetic radiation generated by said analysing system. It is further preferred that the radiation has a wavelength below 10 nm.

Preferably, the method comprises step iv) comprising the step of sorting the panels and/or panel parts, either based upon the one or more identified polymers present in the panel as determined during step iii) and/or based upon the one or more identified tracer materials present in the panel as determined during step ii). Preferably, step ii) and step iii) are computer-implemented method steps. It is imaginable that during step i) an X-ray fluorescence (XRF) spectrometer is used.

Preferably, step i) comprises the sub steps:
a) exposing at least one panel and/or at least one panel parts to X-rays generated by said XRF spectrometer,
b) exciting at least one tracer material embedded in the panel by said X-rays,
c) detecting emitted secondary X-rays emitted by said at least one tracer material by using said XRF spectrometer,
d) processing the detected secondary X-rays by said XRF spectrometer to determine energy and/or spectral position of the emitted secondary X-rays, and wherein step ii) comprises the sub steps:
e) identifying the signature of the tracer material by comparing the energy and/or spectral position of the emitted secondary X-rays with a database comprising data of known tracer materials and their characteristic emission energies and/or spectral positions.

The determination of the identity of at least one matrix material, such as a polymer, used in the panel according to method step iii) may for example be based upon a matrix material list which is presented below.

| Tracer material(s) | Matrix Material |
|---|---|
| Y₂O₃ | PVC |
| CeO₂ | TPU |
| Nd₂O₃ | PET |
| Gd₂O₃ | PP |
| Dy₂O₃ | PE |
| Yb₂O₃ | PS |
| Y₂O₃ + La₂O₃ | MgO and/or Mg(OH)₂ |
| Nd₂O₃ + Er₂O₃ | Gypsum |

Hence, each tracer material and each unique combination of tracer materials is assigned to a specific matrix material. Such a translation table is preferably known by both the manufacturer and the post-use handling company, in particular a recycling company.

It is imaginable that the identification of the at least one tracer material is performed with an identification system comprising: an illumination source, preferably an X-ray source, configured to illuminate a panel to be sorted; a detector, preferably an XRF spectrometer, configured to detect emitted radiation by the tracer material embedded in the polymer matrix, in particular emitted secondary X-rays; an analyzer configured to analyze the detected radiation, in particular the secondary X-rays; a data processing system configured to identify the signature of the tracer material in the polymer matrix; and a sorting device configured to sort the polymers based on the signature of the tracer material in the polymer matrix.

In another preferred embodiment, the identification system comprises a filter positioned between an X-ray source and the panel to be sorted, wherein the filter is configured to reduce noise of the X-rays emitted by the illumination source. It is imaginable that the filter is a metal filter, preferably a metal selected from the group consisting of: aluminium (Al), copper (Cu), zirconium (Zr), iron (Fe), molybdenum (Mo), silver (Ag), and indium (In). Preferably, the detector is a semiconductor detector, and preferably made from a material chosen from the group consisting of: silicon, high purity germanium, and cadmium tellurium.

### BRIEF DESCRIPTION OF THE DRAWINGS

The terms Fig., Figs., Figure, and Figures are used interchangeably in the specification to refer to the corresponding figures in the drawings.

The invention will be elucidated on the basis of non-limitative exemplary embodiments shown in the following figures, wherein,

FIGS. 1a and 1b show a schematic cross-sectional view of a decorative panel according to the present invention, and

FIG. 2 schematically shows a method to identify a polymer in a decorative panel according to the present invention.

### DESCRIPTION OF THE INVENTION

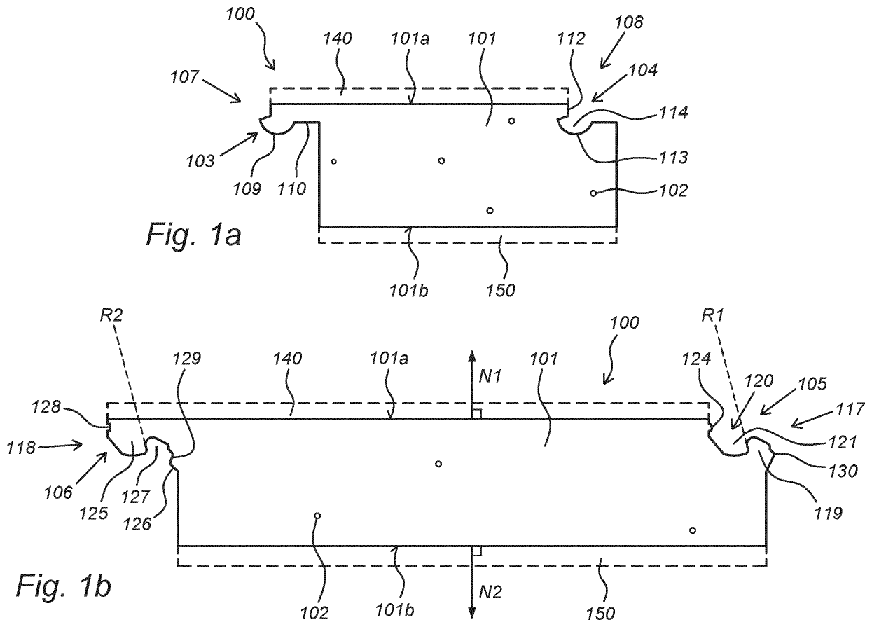

FIGS. 1a and 1b show cross-sectional views of a decorative panel (100) according to the present invention. The panel (100) comprises a core (101) comprising an upper side (101a) and a lower side (101b). A decorative layer (140) is affixed on the upper side (101a) of the core (101). A backing layer (150) is affixed to the lower side (101b) of the core (101). The core (101) is composed of at least one polymer matrix. The polymer matrix is enriched with a tracer material (102). This tracer material (102) is a spectroscopic detectable tracer material. The tracer material can be detected by means of atomic spectroscopy, preferably by means of XRF. Optionally, one or multiple layers of the decorative panel (100) comprise at least one polymer matrix which is enriched with a tracer material (102). The panel (100) further comprises interlocking coupling profiles (103, 104, 105, 106).

FIG. 1a shows a schematic cross-sectional view of a decorative panel (100) comprising a tracer material (102) embedded in the polymer matrix according to the invention. The decorative panel (100) comprises a first edge (107) and an opposing second edge (108), having a first coupling profile (103) and a second coupling profile (104) respectively. The first coupling profile (103) comprises a sideward tongue (109). A front region of the sideward tongue (109) is provided with a rounded bottom surface. An outer end of the rounded bottom surface adjoins an inclined bottom surface. An opposite end of the rounded bottom surface adjoins an inclined locking surface. An opposite end of the rounded bottom surface adjoins a bearing surface (110) making part of a back region of the sideward tongue (109). The second coupling profile (104) comprises an upper lip (112) and a lower lip (113) defining a recess (114). The recess (114) has a complementary shape to the shape of the sideward tongue (109). More in particular, a top surface of a back region of the lower lip (113) has a (complimentary) rounded shape, configured to co-act with the rounded front region of the sideward tongue (109), while a front region of the lower lip (113) is provided with an upwardly protruding shoulder, configured to co-act with the bearing surface of the sideward tongue (109). A lower surface of the upper lip (112) is inclined and corresponds to the locking surface of the sideward tongue (109). Locking at the first edge (107) and the second edge (108) of adjacent panels (100) by insertion of the sideward tongue (109) of a panel (100) to be coupled into the recess (114), wherein said panel (100) is initially held in an inclined position. After insertion of the sideward tongue (109) into the recess (114), the panel (100) to be coupled will be pivoted (angled) in a downward direction about an axis parallel to the first edge (107) until both panels (100) are positioned in the same—commonly horizontal—plane, wherein the locking surface of the sideward tongue (109) will engage the locking surface of the upper lip (112), and wherein at least a bottom front part is accommodated substantially form-fittingly in the recess (114), and wherein the bearing surface is supported by the shoulder. Locking at the first edge (107) and the second edge (108) leads to the locking of the connected panels (100) in both horizontal direction and vertical direction. The angling down locking principle of the first and second edges (107, 108) is a relatively easy locking principle which facilitates the mutual coupling of panels at these edges (107, 108) tremendously.

FIG. 1b shows a schematic cross-sectional view of a decorative panel (100) comprising a tracer material (102) embedded in the polymer matrix according to the invention. The decorative panel (100) comprises a complementary third edge (117) and an opposing fourth (118) edge having a third coupling profile (105) and a fourth coupling profile (106) respectively. The third coupling profile (105) comprises an upward tongue (119), an upward flank (120), and an upward groove (121) formed between the upward tongue (119) and the upward flank (120). A side of the upward tongue (119) facing toward upward flank (120) extends in the direction of the normal N1 of the upper side (101a) of the core (101). The tangent R1 and the normal N1 of the upper side (101a) of the core (101) are thus directed toward each other (converging orientation). Due to the converging orientation of the upward flank (120) and the side of the upward tongue (119) facing toward to the upward flank (120), the upward groove is a closed groove, which is only accessible to a complementary counterpart by deformation of the upward tongue (119). Another side of upward tongue (119) facing toward upward flank (120) forms an aligning edge enabling facilitated realization of a coupling to an adjacent panel (100). A lower part of upward flank (120) is oriented diagonally, while an upper part of upward flank (120) is shown to be substantially vertical and forms a stop surface for the fourth edge (118). In between the inclined part (120) and the substantially vertical part of the upward flank (120) an additional coupling element, in particular an additional bulge (124) is provided. A lower wall part of the upward groove (121) is oriented substantially horizontally in this exemplary embodiment. The fourth edge (118) is substantially complementary to third edge (117). The fourth coupling profile (106) comprises a downward tongue (125), a downward flank (126) and a downward groove (127) formed in between downward tongue (125) and downward flank (126). A side of downward tongue (125) facing toward downward flank (126) lies in the direction of the normal N2 of the lower side (101b) of the core (101). This means that a tangent R2 of side of downward tongue (125) and the normal of the lower side (101b) of the core (101) are mutually converging. Preferably, the inclination of R1 is identical to the inclination of R2; hence, R1 and R2 are preferably parallel. Due to the converging orientation of the downward flank (126) and the side of the downward tongue (125) facing toward to the downward flank (126), the downward groove (127) is a closed groove, which is only accessible for the upward tongue (119) of an adjacent panel (100) by deformation of the downward tongue (125), as a result of which the entrance of the downward groove (127) can be widened (temporary). The inclining side of downward tongue (125) also functions as aligning edge for the purpose of further facilitating coupling between two panels (100). Another side facing away from downward flank (126) takes a substantially vertical form, though is provided with a small cavity (128) configured to co-act with the additional bulge (124) of another panel (100). The downward flank (126) is oriented substantially vertically and is provided with a recess (129) adapted to receive the outward bulge (130) of the upward tongue (119) of an adjacent panel.

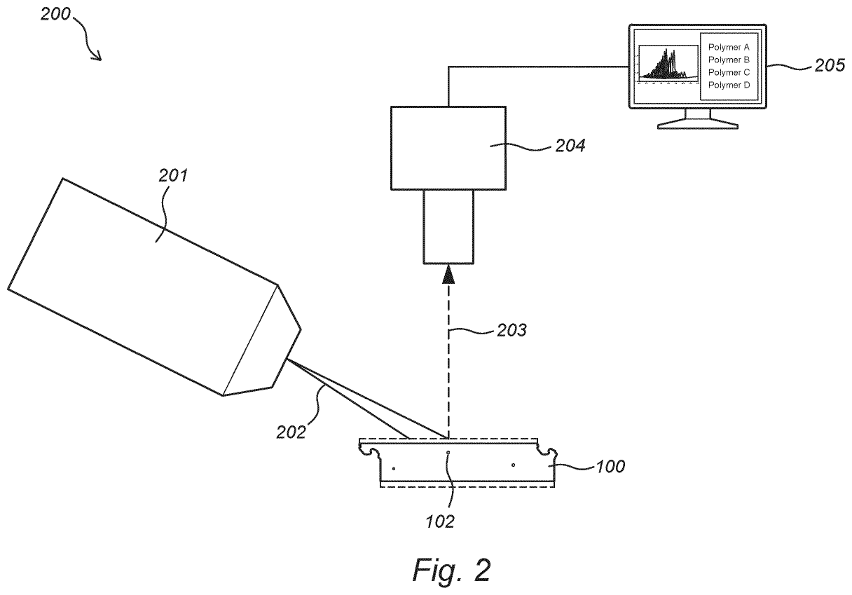

FIG. 2 schematically shows a method to identify a polymer in a decorative panel. The figure shows an identification device (200) to sort panels (100) according to the invention. The figure shows an illumination source (201) that illuminates a decorative panel (100). The panel (100) comprises at least one and optionally more polymers in the polymer matrix embedded with one or more tracer materials (102). The radiation (202) emitted by the illumination source (201) excites the tracer material (201) in the polymer matrix in the panel (100). The excited tracer material (102) emits radiation (203). The radiation (203) is captured by a detector (204). Subsequently, an analyser (205) processes the detected radiation (203). The analyser (205) compares the detected radiation (203) with a database. The database comprises data of the known tracer materials (203) in the polymer matrix in the panel (100). Based on the signature of the detected radiation (203), the tracer material (102) can be related to the polymers in a panel (100). Based on the relation between the tracer material (102) and the polymer a panel can be sorted. This has great advantages for the recycling procedure of post-costumer panels (100).

In another embodiment, the illumination source (201) is an X-ray source. The panel (100) comprises a polymer matrix that is embedded with a tracer material (102) susceptible to XRF. The radiation comprises primary X-rays which are emitted by an X-ray source to excite the tracer material in the panel. The excited tracer material (102) emits secondary X-rays (203), the fluorescent X-rays. The secondary X-rays (203) are captured by a detector (204). Subsequently, an analyser (205) processes the detected secondary X-rays (203). The analyser (205) compares the detected secondary X-rays (203) with a tracer material database. Based on the signature of the detected secondary X-rays (203), the tracer material (102) is identified and can subsequently be related to the matrix material used in a panel (100) by using matrix material retrieval database

This latter database (not shown) preferably includes direct or indirect cross-references between at least one tracer material and at least one matrix material, such as a polymer material, such as, for example, presented in the table below.

| Tracer material(s) | Matrix Material |
|---|---|
| Y₂O₃ | PVC |
| CeO₂ | TPU |
| Nd₂O₃ | PET |
| Gd₂O₃ | PP |
| Dy₂O₃ | PE |
| Yb₂O₃ | PS |
| Y₂O₃ + La₂O₃ | MgO and/or Mg(OH)₂ |
| Nd₂O₃ + Er₂O₃ | Gypsum |

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application.

By “horizontal” is meant a direction which extends parallel to a plane defined by the floor panel, and which may intersect the core. By “vertical” is meant a direction which is perpendicular to said plane defined by the floor panel. The ordinal numbers used in this document, like “first”, “second”, and “third” are used only for identification purposes. Hence, the use of the expressions “third locking element” and “second locking element” does therefore not necessarily require the co-presence of a “first locking element”.

The “floor panel” according to the invention may also applied as wall covering element, ceiling covering element, or alternative covering element.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-57. (canceled)

58. A decorative panel, comprising:
at least one core layer provided with an upper side and a lower side,
a decorative top structure affixed, either directly or indirectly, to said upper side of the core,
a first panel edge comprising a first coupling profile,
a second panel edge comprising a second coupling profile, configured to engage interlockingly with said first coupling profile of an adjacent panel,
wherein said panel is at least partially composed of at least one polymer matrix embedding at least one tracer material susceptible to be identified by means of spectroscopy;
wherein the tracer material is embedded in the polymer matrix at at least two edges of the panel.

59. The panel according to claim 58, wherein the tracer material is only embedded in the polymer matrix at at least two edges of the panel.

60. The panel according to claim 58, wherein at least one tracer material is susceptible to be identified by means of atomic spectroscopy.

61. The panel according to claim 58, wherein at least one tracer material is susceptible to be identified by means of X-ray fluorescence (XRF).

62. The panel according to claim 58, wherein at least one tracer material is or comprises an element with an atomic number equal to or higher than 30.

63. The panel according to claim 58, wherein at least one tracer material is or comprises at least one solid metal, wherein said at least one solid metal is chosen from the group consisting of: Germanium (Ge), Zirconium (Zr), Niobium (Nb), Hafnium (Hf), Tantalum (Ta), Molybdenum (Mo), Iodine (I), Lutetium (Lu), and Tungsten (W).

64. The panel according to claim 58, wherein at least one tracer material is or comprises a rare earth element, wherein at least one rare earth element is chosen from the group consisting of: Yttrium (Y), Lanthanum (La), Neodymium (Nd), Samarium (Sm), Gadolinium (Gd), Cerium (Ce), Praseodymium (Pr), Europium (Eu), Terbium (Tb), Dysprosium (Dy), Erbium (Er), Holmium (Ho), Thulium (Tm), and Ytterbium (Yb).

65. The panel according to claim 58, wherein at least one tracer material comprises at least one rare earth oxide, a rare earth oxide selected from the group consisting of: Y₂O₃, La₂O₃, CeO₂, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, and Yb₂O₃.

66. The panel according to claim 58, wherein at least one tracer material comprises and/or is at least partially derived from monazite, and/or bastnaesite and/or xenotime.

67. The panel according to claim 58, wherein a tracer weight concentration of at least one tracer material in the polymer matrix is the range of 0.1 to 1.0 gram tracer material per kilogram of the polymer matrix.

68. The panel according to claim 58, wherein at least one polymer matrix is at least partially composed of a polymer selected from the group consisting of: polypropylene (PP), polyurethane (PU), thermoplastic polyurethane (TPU), polystyrene (PS), polyethylene (PE), polyethylene terephthalate (PET), and polyvinyl chloride (PVC).

69. The panel according to claim 58, wherein the decorative top structure comprises a plurality of layers.

70. The panel according to claim 58, wherein at least one core layer comprises a polymer matrix and at least one tracer material.

71. The panel according to claim 58, wherein at least one first panel layer comprises a first polymer matrix and at least one first tracer material, and wherein at least second panel layer comprises a second polymer matrix and at least one second tracer material.

72. The panel according to claim 71, wherein the first tracer material and second tracer material are different tracer materials.

73. The panel according to claim 58, wherein the first and/or the seconding coupling profile is provided with at least one coating, wherein said coating comprises at least one tracer material.

74. The panel according to claim 58, wherein the first and/or the seconding coupling profile is at least partially impregnated, wherein said impregnated portion comprises at least one tracer material.

75. The panel according to claim 58, wherein at least one polymer matrix is enriched with at least one additive, at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, and another natural filler, wherein at least one additive is provided with at least one tracer material.

76. The panel according to claim 58, wherein the second coupling profile is configured to engage interlockingly with said first coupling profile of an adjacent panel both in horizontal direction and in vertical direction.

77. A method of manufacturing a decorative panel according to claim 58, comprising the steps:
A) preparing at least one polymer
B) processing said at least one polymer to form at least one panel layer, such as at least one core layer, comprising a matrix of said polymer,
C) affixing, for example, gluing and/or fusing, at least one other panel layer onto the at least one panel layer formed during step B),
D) cutting the laminate of panels created during step C) into panels,
E) providing the panel with complementary coupling profiles at at least one pair of panel edges;
F) embedding, in the polymer matrix at at least two panel edges, at least one tracer material susceptible to be identified by means of spectroscopy,
wherein at least one panel layer of said panel layers constitutes a core layer and at least one other panel layer of said panel layers forms or makes part of a decorative structure of the panel.

78. The method according to claim 77, wherein the mixture preparing during step A) is based upon and/or retrieved from a predefined polymer identifier list, wherein said polymer identifier list comprises a list of a plurality of applicable polymers and/or combinations of polymers, wherein each polymer and/or each combination of polymers is assigned to at least one unique tracer material and/or at least one unique combination of tracer materials, allowing the at least one polymer applied to be identified by means said at least one assigned tracer material susceptible to be identified by means of spectroscopy.

79. The method of identifying a polymer of a decorative panel manufactured by applying the method according to claim 77, comprising the steps of:
i. analysing at least one panel and/or at least one panel part for its elemental composition using an elemental spectroscopic analysis system,
ii. determining the identity of at least one tracer material present in the panel based upon the analysis results collected in step i), by using said analysis system, and
iii. determining the identity of at least one polymer used in the panel, based upon the one or more tracer materials determined during step ii), by retrieving said polymer identity from a predefined polymer identifier list, wherein said polymer identifier list comprises a list of a plurality of applicable polymers and/or combinations of polymers, wherein each polymer and/or each combination of polymers is assigned to at least one unique tracer material and/or at least one unique combination of tracer materials.

80. The method according to claim 79, wherein during step i) an X-ray fluorescence (XRF) spectrometer is used.

81. The method according to claim 80, wherein step i) comprises the sub steps:
a) exposing at least one panel and/or at least one panel parts to X-rays generated by said XRF spectrometer,
b) exciting at least one tracer material embedded in the panel by said X-rays,
c) detecting emitted secondary X-rays emitted by said at least one tracer material by using said XRF spectrometer,
d) processing the detected secondary X-rays by said XRF spectrometer to determine energy and/or spectral position of the emitted secondary X-rays,
and wherein step ii) comprises the sub steps:
e) identifying the signature of the tracer material by comparing the energy and/or spectral position of the emitted secondary X-rays with a database comprising data of known tracer materials and their characteristic emission energies and/or spectral positions.
